(19) United States
(12) Patent Application Publication
(10) Pub. No.: US 2021/0388236 A1
(43) Pub. Date: Dec. 16, 2021

(54) ORANGE COLORING OF TEXTILE SUBSTRATE WITH TRANSITION-METAL- BASED PIGMENT

(71) Applicant: CERTOPLAST TECHNISCHE KLEBE-BANDER GUMBH, Wuppertal (DE)

(72) Inventors: Timo LEERMANN, Wuppertal (DE); Rene RAMBUSCH, Wuppertal (DE)

(21) Appl. No.: 16/647,820

(22) PCT Filed: Aug. 22, 2018
(86) PCT No.: PCT/EP2018/072652

§ 371 Date: Mar. 16, 2020

(30) Foreign Application Priority Data
Nov. 24, 2017 (DE) 202017107156.1

(51) Int. Cl. C09J 7/21; C09J 7/38

(52) U.S. Cl. CPC C09J 7/21; C09J 7/383; C09J 7/385; C09J 2203/302; C09J 2421/00; C09J 2400/263; C09J 2467/006; C09J 2433/00; C09J 2407/00; C09J 2301/41

(57) ABSTRACT

Adhesive tape, in particular wrapping tape for sheathing cables in automobiles, having a textile support and at least one adhesive layer applied to one side or both sides of the support, wherein the support is colored by an in particular yellow dye, characterized in that entirely or partially inorganic mineral pigments are used as the dye. In a preferred embodiment, as pigments of the mineral class of phosphates, arsenates or vanadates, clinobisvanites are used.

The invention relates to an adhesive tape, in particular wrapping tape for sheathing cables in automobiles, having a textile substrate and at least one adhesive layer applied to one or both faces of the substrate, wherein the substrate is colored by a dye.

The coloring of textile substrates in adhesive tapes has been carried out for years, wherein in history, among other things, inorganic soot-based pigments, which have been used as an additive in an extrudate, have been used. For example, filaments and a filament fabric can be produced from the extrudate. More details about the inorganic pigments used are not given (see WO 2003/033611 [US 2004/0253889]).

In the case of another adhesive tape, according to EP 2,546,317 [U.S. Pat. No. 9,695,339], the textile substrate is colored by a mixture of dyes and/or pigments. The mixture itself is composed of yellow and red dyes or pigments. The yellow dye is based on anthraquinone, while the red dye consists of an azo compound. Alternatively, the red dye may also be a mixture of anthraquinone and azo compounds.

As usual, the term “dye” denotes, according to the description in “Rompp Chemie Lexikon, 9th edition, 1993, page 1301,” a collective term for colorants soluble in solvents and/or binders. The dyes are thus contrasted with the insoluble pigments that are inferior to the dyes in number, structural variety, and usually also in luminosity.

“Pigment” is understood to mean, in the medium of application, a practically inorganic or organic colored or uncolored colorant in accordance with “Rompp Chemie Lexikon, 9th edition, 1995, page 3439.” Accordingly, a distinction must be made below between dyes on the one hand and pigments on the other hand according to these definitions.

A technical adhesive tape with a web textile colored substrate is namely the subject matter of EP 1,607,459 [U.S. Pat. No. 8,143,524]. The textile substrate consists in detail of filament or fibers colored by a spinning nozzle. Usually, black coloring is carried out using soot-based material.

The coloring of adhesive tapes or the coloring of the substrate thereof by dyes is of increasing importance. This is because when using such adhesive tapes for sheathing cables in automobiles, it is increasingly demanded that these wrapping tapes, in addition to their actual function for grouping and bundling the cables, provide a comprehensive warning or notification function.

For example, in hybrid and electric cars, it is known that cables or bundles of cables carrying voltages of more than 60 volts must be orange. Here, in 2010 the hue RAL2003 (pastel orange) was specified as standard hue. EP 2 546 317 takes this circumstance into consideration by using the mixture of yellow pigments and red pigments already mentioned above, whereby the yellow pigments are based on anthraquinone and the red pigments are based on an azo compound.

The well-known procedure according to EP 2 546 317 is not free of deficiencies. Thus, with the known organic dyes, there is still the problem that due to heat and/or due to age, there is a discoloration or fading of the coloring and consequently of the substrate and thus the adhesive tape as a whole. This is particularly detrimental in the long term as it can reduce the warning effect or the warning effect can even disappear completely in connection with unavoidable pollution in this area. This is where the invention begins.

The object of the invention is to further develop such an adhesive tape and in particular wrapping tape for sheathing cables in automobiles in such a way that in particular the long-term and temperature stability are improved as well as a continuous warning effect can be obtained.

In order to attain this object, the invention proposes in a generic, adhesive tape and in particular wrapping tape for sheathing cables in automobiles, to use entirely or partially inorganic mineral pigments as dye.

The inorganic mineral pigments provided according to the invention, which entirely or partially form the dye, are advantageously those of the mineral class of oxides and hydroxides. Alternatively or additionally, inorganic mineral pigments can be used in the mineral class of phosphates, arsenates, or vanadates. The classification and designation of the mineral classes is carried out in accordance with the “classification of minerals” according to Strunz (8th edition).

Pyrochlores or rutiles are generally used as pigments of the mineral class of oxides and hydroxides. In fact, pyrochlores crystallize usually in the cubic crystal system and form octahedric crystals with brown, red, orange, or yellowish color. Rutiles are minerals that crystallize usually in the tetragonal crystal system.

Particularly preferably, metal-based pyrochlores or rutiles are used as pyrochlores or rutiles and here in particular transition-metal pyrochlores or rutiles. This means that at this point, the minerals in question, i.e. pyrochlores or rutiles, are used in such a way that transition metals are incorporated into their crystal lattice, for example those based on niobium or zinc. This means that niobium-tin based or tin-zinc based transition-metal pyrochlores or rutiles are preferably used.

Clinobisvanites are particularly advantageously used as pigments of the mineral class of phosphates, arsenates, or vanadates. Such clinobisvanites fall into the group of anhydrous phosphates without foreign anions and typically have a yellow to orange-yellow color. Preferably, the inorganic mineral pigment entirely has a yellow color.

In this way, the invention makes use of the fact that such inorganic mineral pigments typically have a high temperature stability due to their crystal structure and also have a high color fastness. This can be attributed to the special structure and stability of the crystals or minerals used at this point. In fact, the pigments in question and the substrates or adhesive tapes produced are temperature stable in a test in accordance with standard LV 312 (“Protection systems for line sets in motor vehicles, adhesive tapes; Test Directive” October 2009) for a period of 3000 hours, taking into account temperatures well above 150° C., usually even 200° C., or even 250° C. In other words, taking into account the inorganic mineral pigments according to the invention used as dye for the substrate, at least the temperature class T4 is reached according to the standard LV 312, as described in principle in the above-cited EP 2 546 317.

Examples of suitable inorganic mineral pigments in the form of, among other things, niobium tin pyrochlor (NTP) are offered by the company “The Shepard Color Company” and are provided in yellow color. Reference is made to U.S. Pat. No. 8,192,541.

The so-called “Pigment Yellow 53, nickel titanate” has proven particularly favorable as a further suitable pigment from the class of rutiles. Pyrochlores are used by way of example with “Pigment Yellow 227” and for clinobisvanites by way of example with “Pigment Yellow 184, Bismutvanalate.” The above pigments are offered, for example, by the company Habich GmbH from A-3652 Leiben under the label “Duropal.”

Very particularly preferred is an embodiment of the invention, in which the dye is a mixture of yellow inorganic mineral pigments and red organic pigments. Alternatively, the dye may also be a mixture of yellow inorganic mineral pigments and red inorganic pigments. The red organic pigments are advantageously those from the class of perylenes, and of course also further classes are conceivable. If red inorganic pigments are used, the invention again recommends the use of those from the group of pyrochlores. The mentioned red pigments are also offered by the above-mentioned company Habich under the mentioned trade name Duropal.

The yellow dye can be made on the basis of inorganic mineral pigments under use of a yellow niobium-tin-pyrochlor mineral for example. While the inorganic mineral pigments are typically present and used in yellow color, red organic pigments may also be used if the dye is a mixture of yellow inorganic mineral pigments red organic pigments. As an alternative to the above-mentioned red organic pigments from the class of perylenes, red pigments from an azo compound can also be used.

In any case, an orange coloring of the substrate and thus of the adhesive tape can be attained with the help of a dye mixture of the yellow inorganic mineral pigments and the red organic or inorganic mineral pigments.

In particular, the color RAL 2003 (pastel orange) required for the applications described above can be specified and adjusted. Organic pigments based on an azo compound are compounds that have already been described in principle in EP 2 546 317, which are referred to at this point.

The coloration of the substrate can be carried out in principle by a spinning nozzle coloring, so that the dye is added to an extrudate and penetrates during the extrusion into the thus produced fibers and thus colors same.

The preferably used spinning nozzle coloring is carried out in such a way that the dye or the pigments usually have a grain size of less than 0.5 mm, in particular less than 100 μm and preferably of less than 50 μm. Also, it has proven favorable for the mixture of the inorganic mineral pigments with the organic pigments, if the mixing ratio is located in the range of 20:80 to 80:20 mass fractions of the inorganic to the organic pigments. Finally, the pigments in the extrudate are usually caused to be present in a concentration of 0.2 to 3.0 mass-% during the spinning nozzle coloring, based on the polymeric spinning compound, and are then extruded together with the polymeric spinning compound.

In addition, so-called piece coloration is possible in principle, for example by coloring the substrate in a dispersion. The coloring may be carried out from an aqueous solution of the pigments with, if necessary, additional use of auxiliary agents, as described in principle in EP 2 546 317 in this context. Generally, however, the invention uses a spinning nozzle coloring.

The substrate is at least partly made of polyester, polypropylene, polyethylene or polyamide fibers. Particularly preferably, the substrate is made of polyester fibers. Here, in principle, any kind of textile substrates have proven favorable, for example a fleece, a fabric, or even a mesh. In addition, in this way, multilayered substrates are conceivable, in principle for example, from a fleece or fabric and can be produced and colored in the manner described.

The weight of the substrate can normally be up to 200 g/m² and preferably even up to 500 g/m². For the adhesive compound or the adhesive layer made in this way, an application weight in the range of 20 g/m² to 200 g/m² is considered particularly favorable.

For the realization of the adhesive layer, the invention recommends adhesive compounds based on natural rubber or on synthetic rubber. Particularly preferred are adhesive compounds based on acrylate and here in particular acrylate melt adhesive compounds that can be for example UV cross linked.

The adhesive tape made in this way is particularly advantageously used as wrapping tape for sheathing cables in automobiles. For this purpose, the wrapping tape in question is wound around the elongated cables in a spiral. In principle, however, an axially extending protective sheathing for the cables in question can also be made in this way. In this case, the axial sheathing of the elongated cables is carried out by the adhesive tape or a protective sheath made in this way.

1. An adhesive tape for sheathing cables in automobiles, comprising:
a textile substrate and
at least one adhesive layer applied to one or both faces of the substrate, the substrate being colored by a dye constituted entirely or partially of inorganic mineral pigments.

2. The adhesive tape according to claim 1, wherein the inorganic mineral pigments are of the mineral class of oxides and hydroxides, and/or of phosphates, arsenates, or vanadates.

3. The adhesive tape according to claim 2, wherein pyrochlores or rutiles are used as pigments of the mineral class of oxides and hydroxides.

4. The adhesive tape according to claim 2, characterized, wherein clinobisvanites are used as pigments of the mineral class of phosphates, arsenates, or vanadates.

5. The adhesive tape according to claim 1, wherein the inorganic mineral pigment has a yellow color.

6. The adhesive tape according to claim 1, wherein the dye is a mixture of yellow inorganic mineral pigments and red organic pigments.

7. The adhesive tape according to claim 1, wherein the dye is a mixture of yellow inorganic mineral pigments and red inorganic pigments.

8. The adhesive tape according to claim 1, wherein individual filaments of the textile substrate are colored with the dye.

9. The adhesive tape according to claim 1, wherein the substrate consists at least partially of polyester, polypropylene, polyethylene, or polyamide fibers.

10. The adhesive tape according to claim 1, wherein the adhesive coating is an adhesive compound based on natural rubber, synthetic rubber, acrylate, and preferably an acrylate melt adhesive compound.
